(19) United States
(12) Patent Application Publication
(10) Pub. No.: US 2018/0072011 A1
(43) Pub. Date: Mar. 15, 2018

(54) CUTTING TOOL STRUCTURE, APPARATUS THEREOF, AND LAMINATED STRUCTURE FOR MAKING A HEAT-RETAINING CONTAINER

(71) Applicant: Shih-Ying Huang, Taipei City (TW)

(72) Inventor: Shih-Ying Huang, Taipei City (TW)

(21) Appl. No.: 15/688,935

(22) Filed: Aug. 29, 2017

(30) Foreign Application Priority Data
Sep. 10, 2016 (TW) 105214026
Jan. 16, 2017 (TW) 106200772

(51) Int. Cl. B31B 50/20

(52) U.S. Cl. CPC B31B 50/20; B32B 7/12

(57) ABSTRACT

A cutting tool structure, a manufacturing apparatus thereof, and a laminated structure for making a heat-retaining container are proposed. The cutting tool includes: a body; a blade portion extending in a lengthwise direction from the body; and a suppressing portion provided on one side of the body where the blade portion is formed for suppressing the foamed material. The cutting tool structure allows lamination of a foamed sheet and a paper substrate while forming a tear line on the foamed sheet to simplify the manufacturing process of the laminated structure for making a heat-retaining container.

### BACKGROUND

### 1. Technical Field

The present disclosure relates to heat-retaining containers, and, more particularly, to an apparatus and cutting tool structure for preparing a heat-retaining container and a laminated structure for making the heat-retaining container.

### 2. Description of the Prior Art

With the development of science and technology, the demands for better quality of life have increased. In particular, not only the demands for better taste in food and beverage have increased, so do the demands for convenience of these foods, and hence the appearance of highly convenient fast food. In general, these ready-to-eat (“convenient”) foods tend to use disposable containers, which would be thrown away by users after consumption. However, the containers used for holding the food generally have very poor heat insulation. At room temperature, food will lose its original temperature (cold or warm) fairly quickly. This may degrade or even deteriorate its flavor.

In the early days, in order to maintain the original flavor of the convenient fast-food products, foamed materials with better heat-retaining effect such as Styrofoam were used as the material of the disposable container for fast food. However, Styrofoam is extremely energy-consuming and not environmentally friendly in terms of production.

For this reason, a foamed material made of expanded polystyrene is now usually formed on the outside of a paper container body to produce a heat-retaining paper container.

As shown in FIG. 1, a conventional heat-retaining paper container 1 includes a paper container body 10 having a waterproof layer 100 therein, an adhesive layer 11 formed on an outer surface of the paper container body 10, and a foamed material 12 adhered to the paper container body 10 via the adhesive layer 11 such that the conventional heat-retaining paper container 1 has a heat-retaining effect.

There are typically two ways for making heat-retaining paper containers. One is to adhere an insulation material on the outside of the paper container to achieve the heat-retaining effect. Another approach is to coat the paper container with a material to be foamed and then the material is expanded (foamed) to obtain an insulation paper container with a heat-retaining material.

Considering the thickness of the foamed material or the foaming condition, if the foamed material is formed on the entire surface of a semi-finished paper container, it is necessary to design a different insulation container processing machine separate from the existing paper container processing machine. Therefore, in the conventional process of making heat-retaining containers, paper containers are first formed, and the foamed material is adhered to the paper container.

Therefore, there is a need in the industry for manufacturing heat-retaining paper containers using a standard paper container processing machine.

### SUMMARY

In view of the aforementioned shortcomings of the prior art, the present disclosure provides a cutting tool structure for cutting a foamed material, an apparatus for manufacturing a laminated structure of a heat-retaining container, and a laminated structure for making a heat-retaining container to simplify the laminated structure for making the heat-retaining container.

The cutting tool may include: a body; a blade portion extending in a lengthwise direction from the body; and a suppressing portion provided on one side of the body where the blade portion is formed and configured for suppressing the foamed material.

In an embodiment, the suppressing portion has a width between 0.5 mm and 20 mm. In another embodiment, the blade portion has a width between 0.1 mm to 2 mm.

In an embodiment, the blade portion and the suppressing portion each include a distal end away from the body, with a gap formed between the two distal ends. In another embodiment, the gap is between 0.5 mm to 10 mm. In yet another embodiment, the gap is between ¼ and 2 times a thickness of the foamed material.

In an embodiment, the suppressing portion is integrally formed with the body.

In an embodiment, the blade portion includes a distal end away from the body, and the suppressing portion includes a beveled or curved face extending from the distal end towards the body.

In an embodiment, the blade portion has a ring structure, and the suppressing portion is disposed inside the ring structure and has a ring structure.

In an embodiment, the blade portion includes a distal end away from the body, and the distal end has a serrated profile.

The present disclosure further provides an apparatus for manufacturing a laminated structure of a heat-retaining container, which may include: a transport unit configured for carrying and transporting a paper substrate and a foamed sheet provided on the paper substrate; and a stamping unit including the cutting tool structure described above provided above the stamping unit, wherein the suppressing portion and the blade portion are directed at the foamed sheet, the suppressing portion is configured to suppress a portion of the foamed sheet to laminate the foamed sheet on the paper substrate, and the blade portion is configured to damage a foamed structure at a periphery of the foamed sheet laminated on the paper substrate.

In an embodiment, the stamping unit further includes a heater configured for heating the cutting tool structure.

In an embodiment, the apparatus further comprises a winding unit provided at a downstream of the cutting tool structure and configured for removing a portion of the foamed sheet free from being laminated on the paper substrate.

In an embodiment, the apparatus further comprises a cutting unit provided at a downstream of the cutting tool structure and configured for cutting the paper substrate to obtain the laminated structure, wherein the paper substrate defines a central region and a peripheral region surrounding the central region, and the foamed sheet is partially adhered to the central region.

In an embodiment, the cutting tool structure further includes another suppressing portion configured for suppressing and laminating a portion of the foamed sheet on the paper substrate.

In an embodiment, the stamping unit is a planar die-cutting machine or a rotary die-cutting machine.

The present disclosure further provides a laminated structure for making a heat-retaining container, which may include: a paper-based layer defined with a central region and a peripheral region surrounding the central region at a periphery of the paper-based layer; a polymer layer at least formed in the central region and on a surface of the paper-based layer in proximity to the peripheral region; and a foamed sheet partially adhered on the central region of the paper-based layer, wherein the foamed sheet in the central region near the peripheral region is bonded to the polymer layer.

In an embodiment, the peripheral region includes a rolling portion and a bottom edge portion opposite to each other, and a first overlapping portion and a second overlapping portion opposite to each other, and the first overlapping portion and the second overlapping portion are connected to two ends of the rolling portion and the bottom edge portion, respectively.

In an embodiment, the laminated structure further comprises a leveling component formed at a joint area between the rolling portion and the second overlapping portion. In another embodiment, the leveling component is formed of a foamed material. In yet another embodiment, the laminated structure for making a heat-retaining container may include a leveling component formed at a joint area between the rolling portion and the second overlapping portion.

In an embodiment, a gap is formed at an area where the rolling portion and the second overlapping portion are adjacent to each other, such that when the first and second overlapping portions are overlapped, a portion of the first overlapping portion connected with the rolling portion does not overlap with the second overlapping portion.

In an embodiment, the foamed sheet has a flat edge.

In an embodiment, the foamed sheet has an open-bubble structure at an edge thereof.

In an embodiment, the foamed sheet contains the same material as the polymer layer.

Since the cutting tool structure according to the present disclosure includes both a blade portion and a suppressing portion, the foamed sheet is allowed to be cut while pressure and heat are applied thereto, so it is bonded with the polymer layer.

In the laminated structure for making a heat-retaining container according to the present disclosure, by partially adhering the foamed sheet onto the central region of the paper-based layer, the peripheral region of the laminated structure for making a heat-retaining container only has the thickness of the paper-based layer itself or plus the thickness of the polymer layer, so the heat-retaining container is not affected by the thickness of the foamed sheet, and can be processed by a standard paper container processing machine. Moreover, as the foamed sheet is only partially adhered onto the paper-based layer, when the container is being recycled, the foamed sheet can be easily peeled off to facilitate the separation process.

Furthermore, the leveling component such as a foamed material is provided at an area where the rolling portion is connected with the second overlapping portion, so that when overlapping and rolling processes are subsequently carried out by a paper container processing machine, the heat of the processing will lightly melt or soften the leveling component, which overflows beyond the intersection of the rolling portion and the first and second overlapping portions, thereby avoiding thickness difference at the overlapping area in a conventional paper container.

The present disclosure also provides the formation of a gap at an area where the rolling portion and the second overlapping portion are adjacent to each other, thereby avoiding thickness difference at the overlapping area in a conventional paper container.

In summary, the laminated structure for making a heat-retaining container of the present disclosure not only can be applied to a traditional paper container processing machine, but also facilitates separation of the paper container body and the foamed sheet as it is only partially adhered to the body at the edge, thereby increasing convenience in resource recycling. In addition, the heat-retaining paper container of the present disclosure also includes a specially-designed rolling portion, which improves sealing of liquid in the container.

### BRIEF DESCRIPTION OF THE DRAWINGS

The present disclosure can be more fully understood by reading the following detailed description of the preferred embodiments, with reference made to the accompanying drawings, wherein:

FIG. 1 is a cross-sectional view of a conventional heat-retaining paper container;

FIGS. 2A-1 to 2D are schematic diagrams illustrating an embodiment of a cutting tool structure according to the present disclosure, wherein FIG. 2A-1 is a schematic diagram of an embodiment of the cutting tool structure according to the present disclosure, FIG. 2A-2 is a cross-sectional view taken along a cross-sectional line 2A-2A in FIG. 2A-1, FIG. 2B is a schematic diagram of another embodiment of the cutting tool structure according to the present disclosure, FIGS. 2C-1 and 2C-2 are schematic diagrams of another embodiment of the cutting tool structure according to the present disclosure, and FIG. 2D is a cross-sectional view taken along a cross-sectional line 2D-2D in FIG. 2A-1;

FIGS. 3A to 3B′ are schematic diagrams illustrating another embodiment of a cutting tool structure according to the present disclosure, wherein FIG. 3A is an isometric view of the cutting tool structure according to the present disclosure, FIG. 3B is a cross-sectional view taken along a cross-sectional line 3B-3B in FIG. 3A, and FIG. 3B′ is a schematic diagram of another embodiment according to the cutting tool structure of the present disclosure;

FIG. 4 is an operational flow of an apparatus for manufacturing a laminated structure of a heat-retaining container according to the present disclosure;

FIGS. 5A to 5C are cross-sectional views of the apparatus for manufacturing a laminated structure of a heat-retaining container according to the present disclosure, wherein FIG. 5B is a cross-sectional view of a stamping unit of the apparatus for manufacturing a laminated structure of a heat-retaining container according to the present disclosure, and FIG. 5C is a cross-sectional view of a winding unit of the apparatus for manufacturing a laminated structure of a heat-retaining container according to the present disclosure;

FIGS. 6A and 6B are schematic views of an embodiment of a stamping unit of an apparatus for manufacturing a laminated structure, wherein FIG. 6B is another embodiment of a stamping unit of an apparatus for manufacturing a laminated structure:

FIGS. 7A and 7B are schematic views of an embodiment of a laminated structure for making a heat-retaining container according to the present disclosure, wherein FIG. 7B is a cross-sectional view taken along a cross-sectional line 7B-7B in FIG. 7A;

FIGS. 8A and 8B are schematic views of another embodiment of a laminated structure for making a heat-retaining container according to the present disclosure, wherein FIG. 8B is a cross-sectional view taken along a cross-sectional line 8B-8B in FIG. 8A; and

FIGS. 9A and 9B are schematic views of yet another embodiment of a laminated structure for making a heat-retaining container according to the present disclosure, wherein FIG. 9B is a cross-sectional view taken along a cross-sectional line 9B-9B in FIG. 9A.

### DETAILED DESCRIPTION OF THE EMBODIMENTS

The present disclosure is described by the following specific embodiments. Those with ordinary skills in the arts can readily understand other advantages and functions of the present disclosure after reading the disclosure of this specification. The present disclosure may also be practiced or applied with other different implementations. Based on different contexts and applications, the various details in this specification can be modified and changed without departing from the spirit of the present disclosure.

It should be noted that the structures, ratios, sizes shown in the drawings appended to this specification are to be construed in conjunction with the disclosure of this specification in order to facilitate understanding of those skilled in the art. They are not meant, in any ways, to limit the implementations of the present disclosure, and therefore have no substantial technical meaning. Without affecting the effects created and objectives achieved by the present disclosure, any modifications, changes or adjustments to the structures, ratio relationships or sizes, are to be construed as fall within the range covered by the technical contents disclosed herein. Meanwhile, terms, such as “up”, “down”, “bottom”, “first”, “second”, “a”, “one” and the like, are for illustrative purposes only, and are not meant to limit the range implementable by the present disclosure. Any changes or adjustments made to their relative relationships, without modifying the substantial technical contents, are also to be construed as within the range implementable by the present disclosure.

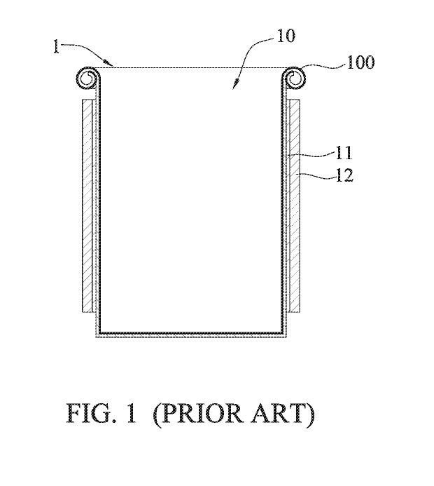

Referring to FIGS. 2A-1, 2A-2, 2B, 2C-1, 2C-2, 2D and 3, cutting tool structures for cutting a foamed material 2A, 2B, 2C-1, 2C-2, 3 and 3′ include: a body 20, 20′ and 30; a blade portion 21, 21′, 21″ and 31′ formed extending in a lengthwise direction from the body 20, 20′ and 30; and a suppressing portion 22, 22′ and 32 for suppressing the foamed material formed on one side of the body 20, 20′ and 30 where the blade portion 21, 21′, 21″ and 31′ is formed.

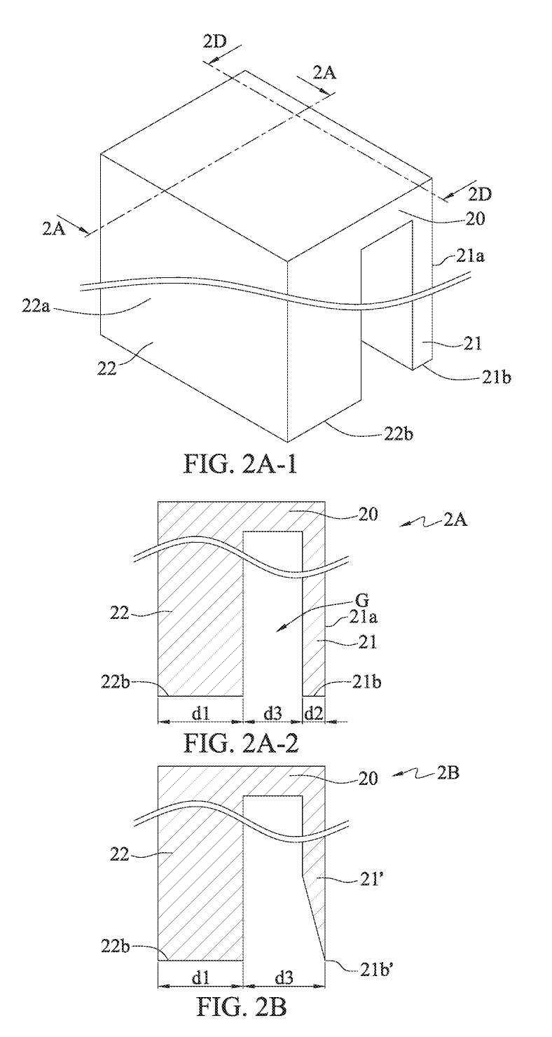

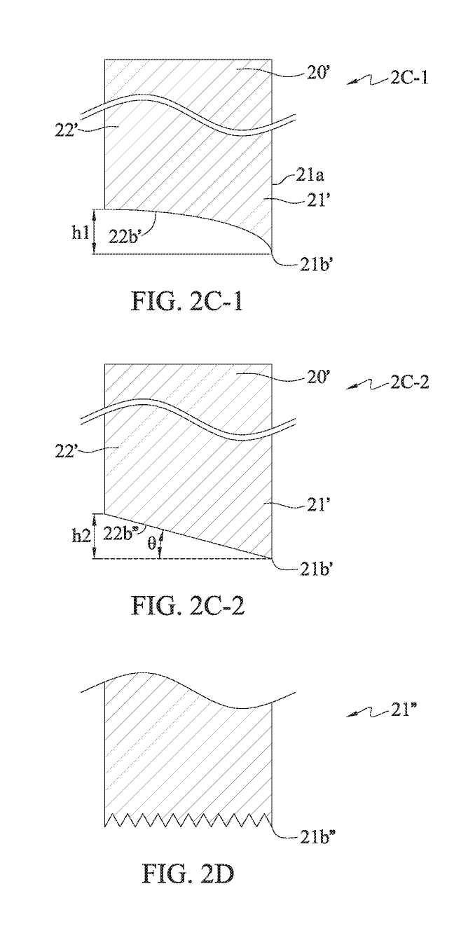

In an embodiment shown in FIG. 2A-1, the suppressing portion 22 is a flat cuboid having a side face 22a and a suppressing face 22b that will come into contact with an object to be cut. The suppressing face has a width d1, and the blade portion 21 is a sheet-like body with a side face 21a and a cutting face 21b that will come into contact with the object to be cut. The cutting face 21b has a width d2. In an embodiment, the blade portion 21 and the suppressing portion 22 are spaced apart. For example, the blade portion 21 and the suppressing portion 22 each has a distal end away from the body 20, and a gap G exists between the two distal ends. The distance d3 of the gap is from 0.5 to 10 mm. In an embodiment of the present disclosure, the distance d3 of the gap G is between ¼ and 2 times the thickness of the foamed material.

In an embodiment shown in FIG. 2B, the blade portion 21′ of the cutting tool structure 2B forms a sharp knife edge at the distal end, i.e., at the corresponding cutting face 21b′ of the blade portion 21′.

In accordance with an embodiment of the present disclosure, the suppressing portion and the blade portion of the cutting tool structure are formed extending in a lengthwise direction (i.e., downwards in the diagram) from the body. The suppressing portion includes a beveled or curved face and is connected with the distal end of the blade portion away from the body. For example, as shown in FIGS. 2C-1 and 2C-2, the blade portion 21′ has a distal end away from the body 20′, and the suppressing portion 22′ has a beveled or curved face extending in a direction from the distal end towards the body 20′. The suppressing portion 22′ and the blade portion 21′ have no gap between them. The suppressing portion 22b′ is a curved face or a concave face as shown in FIG. 2C-1; and the suppressing portion 22b′ is a beveled face as shown in FIG. 2C-2. In an embodiment, when the suppressing portion 22b′ is a curved face or a concave face, the distal end of the blade portion 21′ to the top of the suppressing face 22b′ has a height difference h1, which is less than the thickness of the foamed material to be cut. In an embodiment, the minimum of the height difference h1 is 80%, 70% or even 60% of the thickness of the foamed material to be cut.

In an embodiment, when the suppressing face 22b is a beveled face, an angle θ included by the beveled face and the horizontal plane of the foamed material to be cut is from greater than 0° to 45°, preferably between 15° to 20°. Besides, the end of the blade portion 21′ to the top of the suppressing face 22b′ has a height difference h2, which is less than the thickness of the foamed material to be cut. In an embodiment, the minimum of the height difference h2 is 80%, 70% or even 60% of the thickness of the foamed material to be cut.

In addition, in another embodiment of the present disclosure shown in FIG. 2D, the blade portion has a distal end away from the body. The blade portion has a serrated profile, that is, the blade portion is a serrated blade; in other words, when taken along a cross-sectional line 2D-2D of FIG. 2A-1, the knife edge of the blade portion 21′ is serrated.

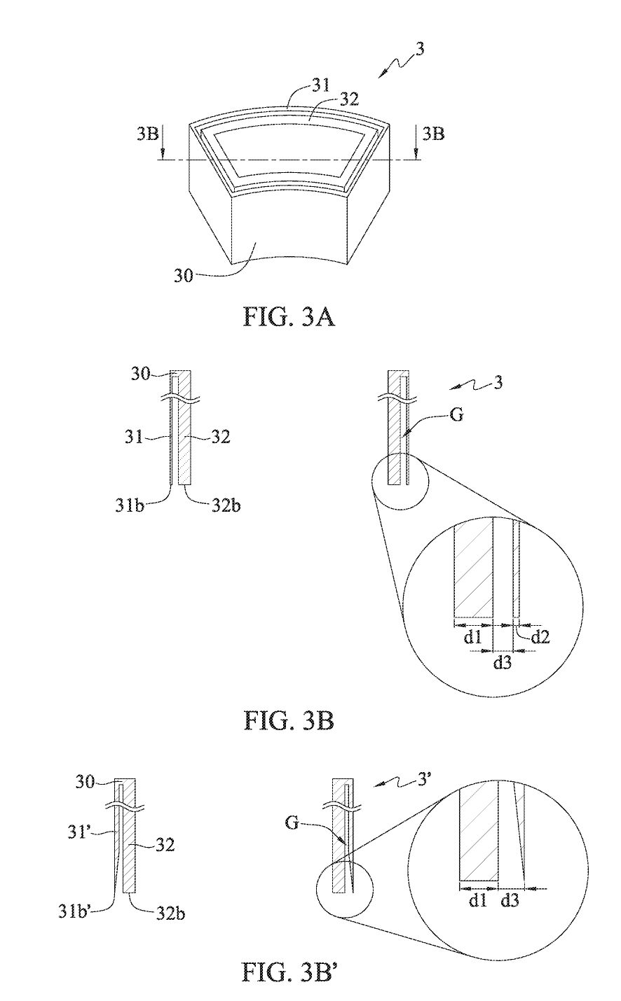

Referring to FIGS. 3A to 3B′, FIG. 3A is an isometric upside down view of the cutting tool structure 3 of the present disclosure. In an embodiment, the blade portion 31 has a ring structure, and the suppressing portion 32 is provided inside the enclosed structure and also has a ring structure.

In FIG. 3B, which is taken from a cross-sectional line 3B-3B in FIG. 3A, the blade portion 31 and the suppressing portion 32 have a gap G at distal ends thereof away from the body.

In an embodiment of the present disclosure, the width d1 of the suppressing portion 22, 32 is between 0.5 and 20 mm, and the width d2 of the blade portion 21, 22 is between 0.1 and 2 mm, and the distance d3 of the gap G between distal ends of the blade portion 22, 31 and the suppressing portion 22 and 32 away from the body is between 0.5 and 10 mm. In a preferred embodiment, the width d1 of the suppressing portion 22, 32 is between 2 and 2.5 mm, the width d2 of the blade portion 21, 22 is between 0.2 and 0.3 mm, the distance d3 of the gap G between distal ends of the blade portion 22, 31 and the suppressing portion 22 and 32 away from the body is between 0.5 and 1.5 mm.

In an embodiment of the cutting tool structure of the present disclosure, the suppressing portion and the body are integrally formed.

Furthermore, since the cutting tool structure according to the present disclosure is designed for foamed materials with certain thicknesses, when a gap G exists between the suppressing portion 22, 32 and the blade portion 21, 31, the distance of the gap G is defined in terms of the thickness of the foamed sheet. In another embodiment, the gap between the blade portion 21, 31 and the suppressing portion 22, 32 is between ¼ and 2 times the thickness of a foamed material to be cut. When no gap exists between the suppressing portion 22′ and the blade portion 21′, a height difference exists between the suppressing face 22b′, 22b″ of the suppressing portion 22′ and the distal end of the blade portion 21′, and is also defined in terms of the thickness of a foamed sheet. For example, the minimum of the height difference is 80%, 70% or even 60% of the thickness of a foamed material to be cut.

In an embodiment, the cutting tool structure according to the present disclosure may further include another suppressing portion (not shown) for suppressing and laminating portions of the foamed sheet on a paper substrate in order to form various patterns.

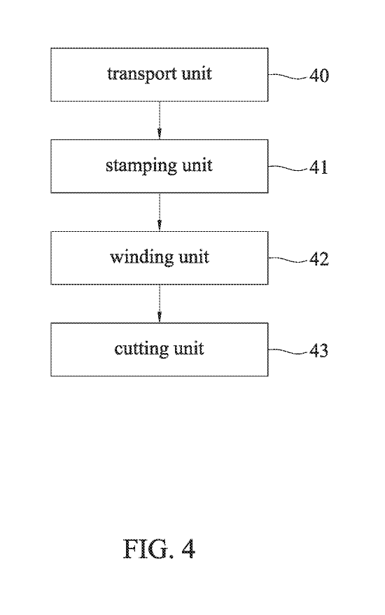

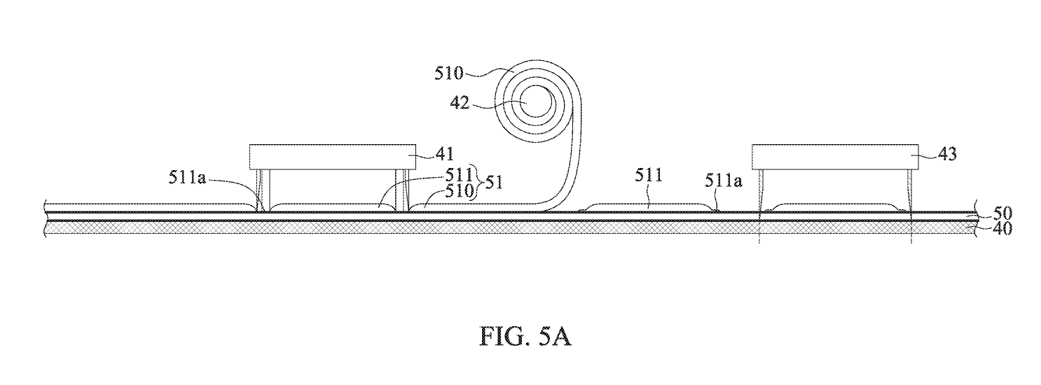

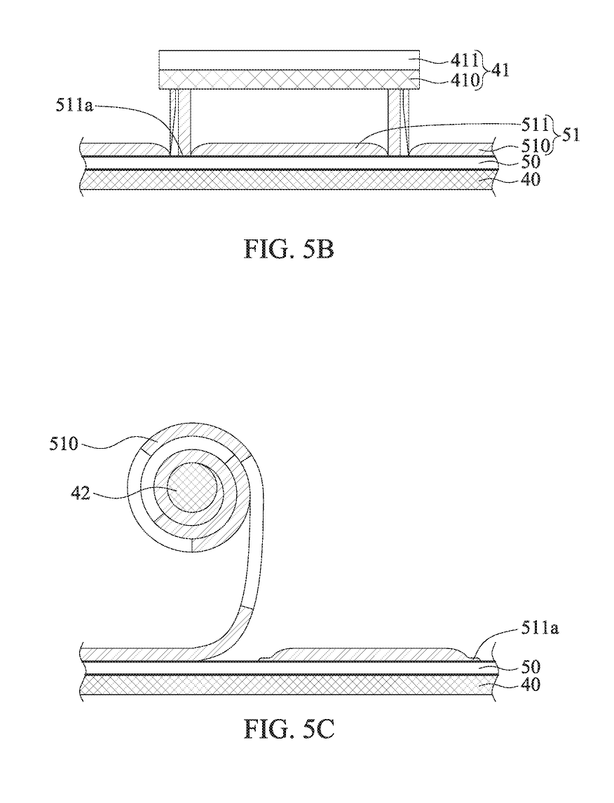

Referring now to FIGS. 4 and 5, an operational flow of an apparatus for manufacturing a laminated structure of a heat-retaining container according to the present disclosure is explained. A transport unit 40 transports and provides paper and a foamed sheet. Then, a stamping unit 41 having the cutting tool structure 2A, 2B, 2C-1, 2C-2, 3, 3′ described with respect to FIGS. 2A to 3B′ laminates a portion of the foamed sheet on the paper substrate. In an embodiment, the cutting tool structure 2A, 2B, 2C-1, 2C-2, 3, 3′ includes a suppressing portion 22, 22′, 32 and a blade portion 21, 21′, 21″, 31 adjacent the suppressing portion 22, 22′, 32, and the suppressing portion 22, 22′, 32 and the blade portion 21, 21′, 21″, 31 face the foamed sheet 51, so that the suppressing portion 22, 22′, 32 presses against a portion of the foamed sheet 51 in order to laminate the foamed sheet 51 onto the paper substrate 50. The blade portion 21, 21′, 21″, 31 is used for damaging foamed structures on the periphery 511a of foamed sheet that is laminated on the paper 511. A winding unit 42 such as a roller is used for recovering a portion of foamed sheet 510 that is not laminated on the paper substrate 50, such that the foamed sheet 511 that is laminated on the paper substrate 50 is separated from the foamed sheet 510 that is not laminated on the paper substrate 50. Finally, a cutting unit 43 having, for example, a cutting knife, is used for cutting off a portion of the paper with the foamed sheet 511 laminated thereon from the paper substrate 50, thereby obtaining a laminated structure of paper with foamed sheet thereon.

In an embodiment, the transport unit 40 can be a conveyor belt or other machine that can independently or individually transport and/or provide the paper substrate 50 and the foamed sheet 51. In an embodiment, the foamed sheet 51 is placed on the paper substrate 50. In an embodiment, the winding unit 42 and the cutting unit 43 are sequentially provided at the downstream of the stamping unit 41, wherein the cutting unit 43 can be integrated with the stamping unit 41. In an embodiment, in addition to the cutting tool structure described previously, the stamping unit 41 also includes an additional cutting mold (not shown) that has a ring structure surrounding the periphery of the ring structure of the blade portion of the cutting tool structure. In another embodiment, the cutting unit 43 can be separately provided after the stamping unit 41 and the winding unit 42.

In an embodiment, the paper substrate is a sheet of paper with polymer layers (e.g., waterproof layers) formed on its surfaces (two surfaces) as shown by the thicker line in the diagrams.

Referring to FIG. 5B, a cross-sectional view of the stamping unit 41 according to the present disclosure is shown. The stamping unit 41 includes one of the cutting tool structures 2A, 2B, 2C-1, 2C-2, 3, 3′ described with respect to FIGS. 2A to 3B′. The stamping unit 41 is used for laminating a portion of the foamed sheet 511 on the paper substrate 50.

In an embodiment, in addition to the cutting tool structure 410, the stamping unit 41 further includes a heater 411 for heating up the cutting tool structure, which facilitates the forming of a tear line on the foamed sheet 51 when the foamed sheet 51 and the paper substrate 50 are thermally pressed and laminated together. In an embodiment, the heat can be directly or indirectly provided. In an embodiment, the cutting tool structure is equipped at a welding terminal of an ultrasonic welding machine. In another embodiment, a blade in a high frequency cutting machine or an ultrasonic cutting machine is replaced by the cutting tool structure 410 according to the present disclosure to facilitate the lamination of the foamed sheet. In an embodiment, the stamping unit 41 is a planar die-cutting machine.

More specifically, the cutting tool structure 2A, 2B, 2C-1, 2C-2, 3, 3′ includes the suppressing portion 22, 22′, 32 and the blade portion 21, 21′, 21″, 31 adjacent the suppressing portion 22, 22′, 32, wherein the suppressing portion 22, 22′, 32 is used for laminating a portion of the foamed sheet 511 onto the paper substrate 50, and the blade portion 21, 21′, 21″, 31 is used for damaging foamed structures at the periphery 511a of the foamed sheet 511 that is laminated on the paper substrate 50 (by melting the foamed sheet or bursting the bubbles), so as to form a tear line on the foamed sheet 511a between the foamed sheets 510 and 511 (at the periphery of the foamed sheet 511).

A cross-sectional view of the winding unit 42 according to the present disclosure is shown in FIG. 5C. The winding unit 42 is used for rewinding un-laminated foamed sheet 510 from the paper substrate 50 in order to separate a portion of the foamed sheet 511 laminated on the paper substrate 50 from the foamed sheet 510 that is not laminated on the paper substrate 50.

In an embodiment, as the stamping unit 41 of the present disclosure (referring to FIG. 5B) has pre-formed a tear line on the foamed sheet 511a between the laminated foamed sheets 510 and the un-laminated foamed sheet 511 (at the periphery of the foamed sheet 511), so when the winding unit 42 is rewinding the foamed sheet 510 from the paper substrate 50, the foamed sheet 510 can be easily torn off, thereby separating the foamed sheet 511 laminated on the paper substrate 50 from the foamed sheet 510 not laminated on the paper substrate 50.

In another embodiment, the stamping unit is a rotary die-cutting machine. For example, the stamping unit stamps in a rolling and die-cutting manner.

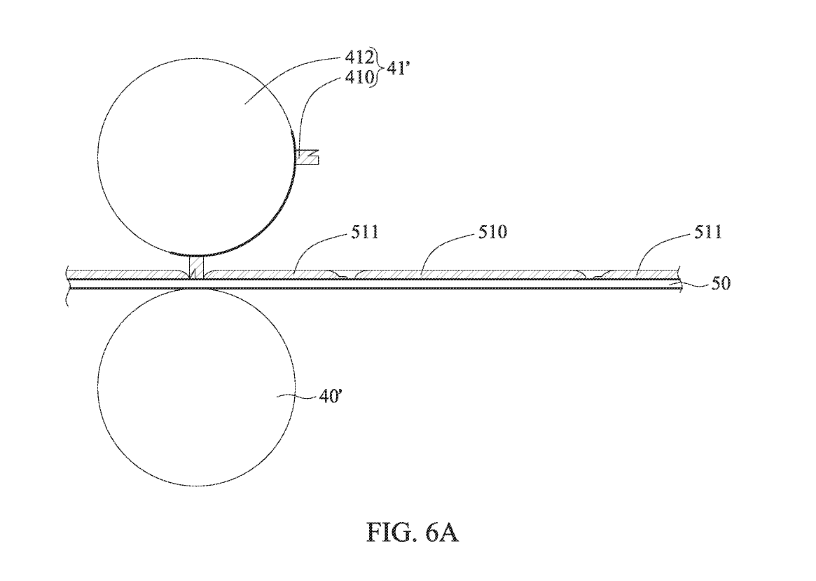

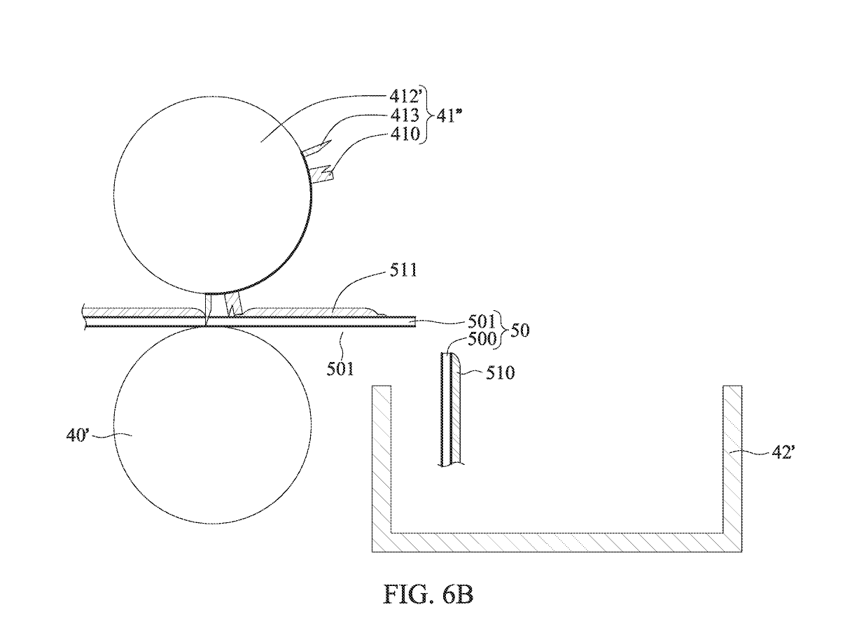

In an embodiment, referring to FIGS. 6A and 6B, which are cross-sectional views of stamping units 41′ and 41″ according to the present invention, respectively, the stamping units 41′ and 41″ have oppositely disposed first rollers 412, 412′, a second roller 40′ and a cutting tool structure 410, which can be one of the cutting tool structures 2A, 2B, 2C-1, 2C-2, 3 and 3′ shown in FIGS. 2A to 3B′. The cutting tool structure 410 is disposed on the first rollers 412, 412′, and the stamping units 41′ and 41″ roll and laminate a portion of the foamed sheet 511 onto the paper substrate 50. In another embodiment shown in FIG. 6B, a cutting knife 413 is further included. The cutting unit and the cutting tool structure 410 are integrated to obtain the stamping unit 41″, and, though a molding process, obtain a laminated structure including the paper substrate 501 and the foamed sheet 511 that is used to manufacture a heat-retaining container. Finally, the embodiment shown in FIG. 6B further comprises a collector 42′ configured for collecting the remaining paper substrate 50 and foamed sheet 510 cut by the cutting unit.

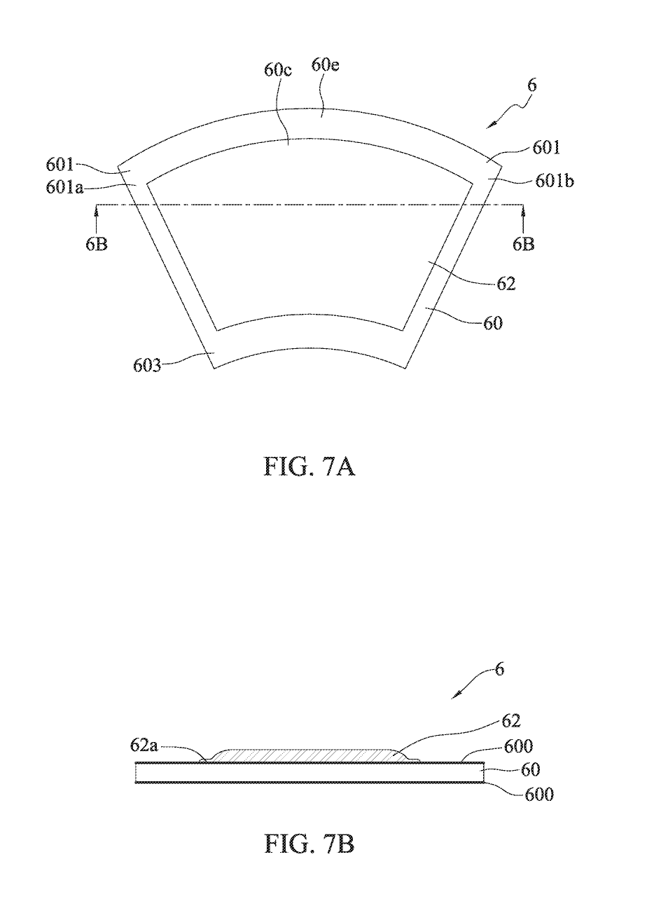

Referring to FIGS. 7A and 7B, a schematic view and a cross-sectional view of a laminated structure for making a heat-retaining container according to the present disclosure are shown.

As shown in FIGS. 7A and 7B, a laminated structure 6 for making a heat-retaining container according to the present disclosure includes a paper-based layer 60, a polymer layer 600 and a foamed sheet 62.

In an embodiment, the surface of the paper-based layer 60 is defined with a central region 60c and a peripheral region 60e surrounding the central region 60c; the polymer layer 600 at least formed in the central region 60c and in proximity to the peripheral region 60e (in an embodiment, the entire two surfaces of the paper-based layer 60 are covered with the polymer layer 600); and the foamed sheet 62 partially adhered to the central region 60c of the paper-based layer 60, wherein areas of the foamed sheet 62 in the central region 60c in proximity to the peripheral region 60e and the polymer layer 600 are melted together, such that the foamed sheet 62 is partially adhered to the central region 60c of the paper-based layer 60. The area of the foamed sheet 62 is approximately the same as that of the central region 60c.

In an embodiment, the peripheral region 60e includes a rolling portion 601 and a bottom edge portion 603 opposite to each other and a first overlapping portion 601a and a second overlapping portion 601b opposite to each other. The first overlapping portion 601a and the second overlapping portion 601b are connected at two ends of the rolling portion 601 and the bottom edge portion 603. The rolling portion 601 will be rolled in to form the cup rim during a paper container manufacturing process. In another embodiment of the present disclosure, a gap exists in an area where the rolling portion 601 and the second overlapping portion 601b are adjacent to each other (not shown). As a result, the length of the second overlapping portion 601b is less than that of the first overlapping portion 601a. This is beneficial in that when the first overlapping portion 601a and the second overlapping portion 601b are overlapped with each other, the portion of the first overlapping portion 601a connected to the rolling portion 601 will not overlap the second overlapping portion 601b, thereby avoiding thickness difference at the overlapping area of the paper container.

In an embodiment, the polymer layer 600 is formed on two opposite surfaces of the paper-based layer 60. In another embodiment, the foamed sheet is formed of a material of the polymer layer. In an embodiment, the polymer layer is made of polyethylene (PE), and the foamed sheet is a material containing PE, such as Expandable PE (EPE). In another embodiment, the polymer layer is made of poly-propylene (PP), and the foamed sheet is a material containing PP, such as Expandable PP (EPP). In an embodiment, the polymer layer is a waterproof layer, and the waterproof layer is PE.

In an embodiment, the paper-based layer 60 is made of paper, and the foamed sheet is made of Expandable Polystyrene (EPS), Expandable Polyethylene (EPE) or Expandable Poly-Propylene (EPP), but they are not limited as such.

In an embodiment, an edge 62a of the foamed sheet 62 corresponding to the central region 60c of the paper-based layer 60 in proximity to the peripheral region 60e is formed by thermal lamination (referring to FIG. 7B). The polymer layer 600 and the foamed sheet 62 at the edge 62a are bonded together.

In an embodiment, the edge 62a of the foamed sheet 62 is flat, the edge 62a corresponding to the tear line (not shown) includes broken bubbles, and an open-cell foam structure is formed.

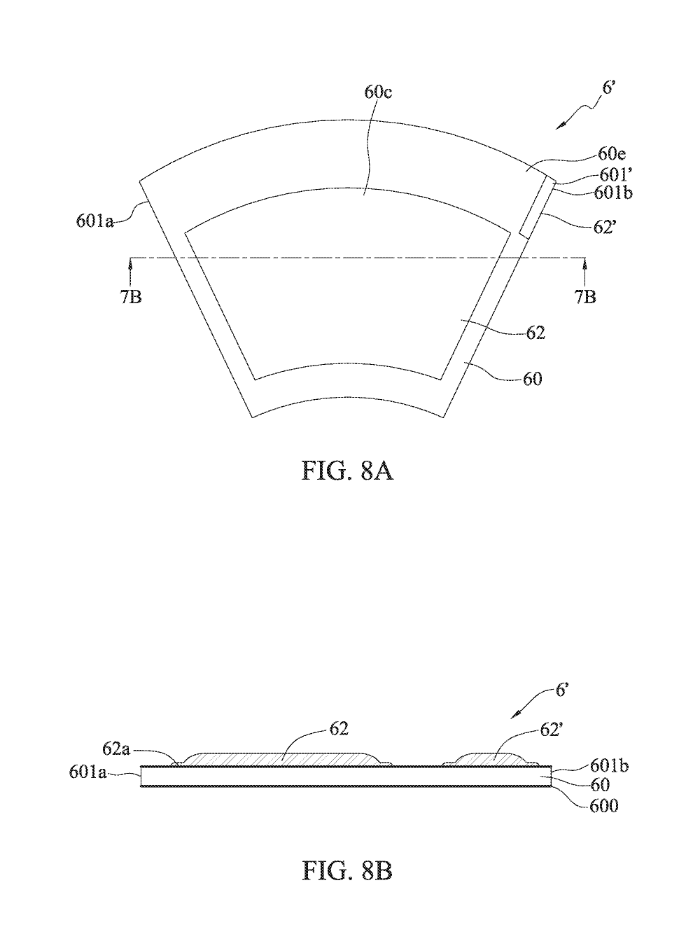

Referring to FIGS. 8A to 8D, an implementation of another laminated structure 6′ for making a heat-retaining container according to the present disclosure is shown. In an area where the rolling portion 601′ is connected with the second overlapping portion 601b, a leveling component 62′ is formed on the paper-based layer 60 or the polymer layer 600. The leveling component 62′ can be a foamed sheet or other thermal plastic or thermal setting material. In an embodiment, the stamping unit 41 is laminating the foamed sheet in the central region 60c, and the leveling component 62′ is formed by laminating another foamed sheet on the connecting or intersecting area between the rolling portion 601′ and the second overlapping portion 601b of the peripheral region 60e as the leveling component 62′. In another embodiment, the leveling component can be separately formed in the shape of a sheet or a block, and can be made of the same or different material from the material of the foamed sheet 62.

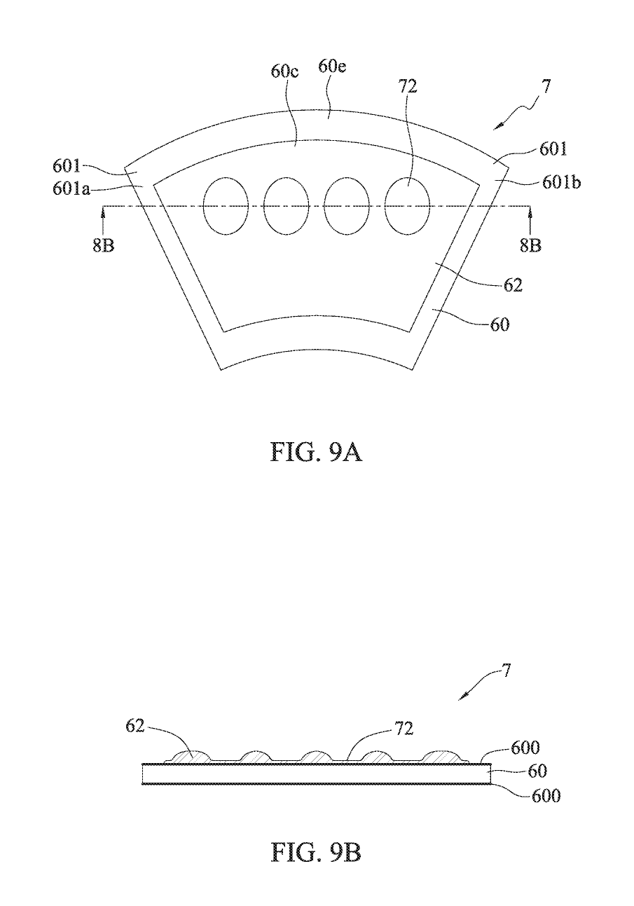

Referring to FIGS. 9A and 9B, an implementation of another laminated structure 7 for making a heat-retaining container according to the present disclosure is shown. In the central region 60c, portions of the foamed sheet are melted with the polymer layer, forming depressed portions 72 (concave ribs) on the foamed sheet 62. The depressed portions 72 include, but are not limited to, geometric shapes, arcs or a specific shape to enhance the grip of the heat-retaining container made from the laminated structure 7.

In an embodiment, the depressed portions 72 can be formed in the central region 60c simultaneously or at a different time to the lamination of the foamed sheet by the stamping unit 41. When the cutting tool structure further includes another suppressing portion, the depressed portions 72 can be formed while laminating the foamed sheet. Of course, the depressed portions 72 can be separately formed.

It can be seen from the above embodiments that the cutting tool structure according to the present disclosure includes both a blade portion and a suppressing portion, which allows the foamed sheet to be cut while pressure and heat are applied to it, so it is partially melted with the polymer layer (e.g., a waterproof layer) on the paper, and thus adhering (laminating) the foamed sheet on the paper at the same time.

Not only that, in the laminated structure for making a heat-retaining container of the present disclosure, by partially adhering the foamed sheet onto the central region of the paper-based layer, the peripheral region of the laminated structure for making a heat-retaining container only has the thickness of the paper-based layer itself or plus the thickness of the polymer layer, so it is not affected by the thickness of the foamed sheet, and the heat-retaining container can be processed by a standard paper container processing machine.

Moreover, as the foamed sheet is only partially adhered onto the paper-based layer, when the container is being recycled, the foamed sheet can be easily peeled off to achieve separation of the paper-based layer and the foamed sheet, greatly enhancing the convenience of resource recycling.

Furthermore, the leveling component is provided at the intersection of the rolling portion and the second overlapping portion, so when overlapping and rolling processes are subsequently carried out by the paper container processing machine, the heat of the processing will lightly melt or soften the leveling component, which overflows beyond the intersection of the rolling portion and the first and second overlapping portions, thus avoiding thickness difference of the paper container. In addition to the above structure, the present disclosure also proposes the formation of a gap at an area where the rolling portion and the second overlapping portion are adjacent to each other, thus avoiding thickness difference at the overlapping area of a conventional paper container, improving the sealing of a sealing film applied to the top opening of the container with liquid inside.

Additionally, the present disclosure also improves the grip of heat-retaining container made from the laminated structure according to the present disclosure by allowing the formation of the depressed portions in geometric, arc or specific shapes on the central region.

The above embodiments are only used to illustrate the principles of the present disclosure, and should not be construed as to limit the present disclosure in any way. The above embodiments can be modified by those with ordinary skill in the art without departing from the scope of the present disclosure as defined in the following appended claims.

What is claimed is:

1. A cutting tool structure for cutting a foamed material, comprising:
a body;
a blade portion extending in a lengthwise direction from the body; and
a suppressing portion provided on one side of the body where the blade portion is formed and configured for suppressing the foamed material.

2. The cutting tool structure of claim 1, wherein the suppressing portion has a width between 0.5 mm and 20 mm.

3. The cutting tool structure of claim 1, wherein the blade portion has a width between 0.1 mm to 2 mm.

4. The cutting tool structure of claim 1, wherein the blade portion and the suppressing portion each include a distal end away from the body, with a gap formed between the two distal ends.

5. The cutting tool structure of claim 4, wherein the gap is between 0.5 mm to 10 mm.

6. The cutting tool structure of claim 4, wherein the gap is between ¼ and 2 times a thickness of the foamed material.

7. The cutting tool structure of claim 1, wherein the suppressing portion is integrally formed with the body.

8. The cutting tool structure of claim 1, wherein the blade portion includes a distal end away from the body, and the suppressing portion includes a beveled or curved face extending from the distal end towards the body.

9. The cutting tool structure of claim 1, wherein the blade portion has a ring structure, and the suppressing portion is disposed inside the ring structure and has a ring structure.

10. The cutting tool structure of claim 1, wherein the blade portion includes a distal end away from the body, and the distal end has a serrated profile.

11. An apparatus for manufacturing a laminated structure of a heat-retaining container, comprising:
a transport unit configured for carrying and transporting a paper substrate and a foamed sheet provided on the paper substrate; and
a stamping unit including the cutting tool structure of claim 1 provided above the transport unit, wherein the suppressing portion and the blade portion are directed at the foamed sheet, with the suppressing portion being configured to suppress a portion of the foamed sheet to laminate the foamed sheet on the paper substrate, and the blade portion being configured to damage a foamed structure at a periphery of the foamed sheet laminated on the paper substrate.

12. The apparatus of claim 11, wherein the stamping unit further includes a heater configured for heating the cutting tool structure.

13. The apparatus of claim 11, further comprising a winding unit provided at a downstream of the cutting tool structure and configured for removing a portion of the foamed sheet free from being laminated on the paper substrate.

14. The apparatus of claim 11, further comprising a cutting unit provided at a downstream of the cutting tool structure and configured for cutting the paper substrate to obtain the laminated structure, wherein the paper substrate defines a central region and a peripheral region surrounding the central region, and the foamed sheet is partially adhered to the central region.

15. The apparatus of claim 11, wherein the cutting tool structure further includes another suppressing portion configured for suppressing and laminating a portion of the foamed sheet on the paper substrate.

16. The apparatus of claim 11, wherein the stamping unit is a planar die-cutting machine or a rotary die-cutting machine.

17. A laminated structure for making a heat-retaining container, comprising:
a paper-based layer defined with a central region and a peripheral region surrounding the central region at a periphery of the paper-based layer;
a polymer layer at least formed in the central region and on a surface of the paper-based layer in proximity to the peripheral region; and
a foamed sheet partially adhered to the central region of the paper-based layer, with a portion of the foamed sheet in the central region near the peripheral region being bonded to the polymer layer.

18. The laminated structure of claim 17, wherein the peripheral region includes a rolling portion and a bottom edge portion opposite to each other, and a first overlapping portion and a second overlapping portion opposite to each other, wherein the first overlapping portion and the second overlapping portion are connected to two ends of the rolling portion and the bottom edge portion, respectively.

19. The laminated structure of claim 17, further comprising a leveling component formed at a joint area between the rolling portion and the second overlapping portion.

20. The laminated structure of claim 19, wherein the leveling component is formed of a foamed material.

21. The laminated structure of claim 18, wherein the rolling portion and the second overlapping portion are formed with a gap at an adjacent area of the rolling portion and the second overlapping portion, with a portion of the first overlapping portion connected with the rolling portion free from overlapping with the second overlapping portion when the first overlapping portion overlaps with the second overlapping portion.

22. The laminated structure of claim 17, wherein the foamed sheet has a flat edge.

23. The laminated structure of claim 17, wherein the foamed sheet has an open-bubble structure at an edge thereof.

24. The laminated structure of claim 17, wherein the foamed sheet contains the same material as the polymer layer.
